(19) United States
(12) Patent Application Publication
(10) Pub. No.: US 2007/0021581 A1
(43) Pub. Date: Jan. 25, 2007

(54) Trimerization Catalysts

(75) Inventors: Christian Eilbracht, Herne (DE); Manfred Klincke, Castrop-Rauxel (DE); Torsten Metz, Essen (DE); Carsten Schiller, Muelheim a.d. Ruhr (DE)

Correspondence Address: FROMMER LAWRENCE & HAUG, 745 FIFTH AVENUE- 10TH FL., NEW YORK, NY, 10151, US

(73) Assignee: Goldschmidt GmbH, Essen (DE)

(21) Appl. No.: 11/459,099

(22) Filed: Jul. 21, 2006

(30) Foreign Application Priority Data
Jul. 21, 2005 (DE) 10 2005 034 052.0

(51) Int. Cl. C08G 18/16; B01J 31/00

(52) U.S. Cl. 528/48; 502/150; 502/152; 502/155; 502/168; 502/167

(57) ABSTRACT

The invention relates to a trimerization catalyst system comprising at least 50% by weight of potassium octoate and a hydroxy-group-free and amino-group-free solvent which, under the reaction conditions, is inert toward the isocyanates used, to its use for the trimerization of isocyanates to give isocyanurates and/or polyisocyanurates, and to a process for production of PIR foams using the inventive trimerization catalyst system and PIR foams.

Any foregoing applications, and all documents cited therein or during their prosecution (“application cited documents”) and all documents cited or referenced in the application cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

The invention relates to a trimerization catalyst system for isocyanates, to its use, and to a process for production of PIR foams, and also to correspondingly produced PIR foams.

Polyurethane foam is an insulation material whose thermal insulation capability is superior to that of other materials, e.g. polystyrene foams, glass wool, and mineral wool, and it is therefore becoming increasingly important in the thermal insulation of buildings. However, fire protection specifications apply to this application and polyurethane (PU) technology can comply with these specifications only via use of considerable amounts of flame retardants (e.g. tri(chloroisopropyl) phosphate, triethyl phosphate). PIR technology known per se (PIR=highly crosslinked polyisocyanurate) can achieve relatively low flammability of the underlying polymeric substance and thus save flame retardant. The difference here from PU technology is that the amount of isocyanate used alongside the polyol component for the polyaddition reaction with isocyanates is from 2 to 3 times greater than would be required stoichiometrically for the reaction of all of the OH groups of the polyol component. The excess isocyanate groups are trimerized via a suitable catalyst to give isocyanurate groups. Isocyanurate has the chemical formula:

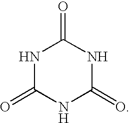

The isocyanurate groups lead to additional crosslinking of the polymer; the isocyanurate groups may include polymerized or derivatized forms thereof. Catalysts which are suitable and are known in principle for use in PIR technology are potassium salts of carboxylic acids, in particular potassium 2-ethylhexanoate (potassium octoate), and potassium acetate.

Potassium octoate is a solid. Because, however, polyurethane producers' equipment permits handling only of liquid substances, the potassium octoate has to be dissolved. Solutions of strength about 75% by weight in monoethylene glycol or diethylene glycol are prior art. These solutions are supplied by various producers. Examples of typical products are

| | |
|---|---|
| KOSMOS ® 75 MEG | Goldschmidt |
| Pel-Cat 9540A | Ele-Pelron |
| Pel-Cat 9865 | Ele-Pelron |
| Dabco K-15 | Air Products |

Because the glycols used as solvents have free OH groups, they react with the isocyanates used, for example methylene 4,4′-bis(phenyl isocyanate) (MDI), and in this process consume a certain proportion of the isocyanate groups. This consumption has to be taken into account in the calculation of a PIR formulation, this means that for a desired ratio of NCO groups to OH groups the amount of MDI required is more than would be without the OH groups present in the catalyst. In typical formulations, this consumption of MDI via the catalyst is from 3 to 10% by weight of the entire amount of MDI used.

An object of the invention is therefore to provide a trimerization catalyst system which can be pumped at room temperature (25° C.), i.e. which is flowable, and which is based on potassium octoate, for PIR foam production, and which, when compared with the prior art, permits reduced consumption of MDI. The catalytic activity of this catalyst system (based on the same potassium octoate content) is intended to be as close as possible to that of established products which comprise glycols as solvent.

Furthermore, the intention is to avoid any impairment of the properties of PIR foams produced using the catalyst, when comparison is made with foams produced with conventional catalyst solutions. The solvent is moreover to meet the requirements arising from the catalyst-preparation process. It should have adequate chemicals resistance and should not be classified as toxic (T) or very toxic (T+) under European chemicals legislation.

According to the invention, the object is achieved via a trimerization catalyst system for isocyanates comprising at least about 50% by weight of potassium octoate and a hydroxy-group-free and amino-group-free solvent which, under usual reaction conditions, is substantially or completely inert toward the isocyanates used.

In one embodiment of the invention, the trimerization catalyst systems whose potassium octoate content is selected from the ranges of at least about 60% by weight, from about 65 to about 90% by weight and from about 65 to about 75% by weight.

The inventive trimerization catalyst system avoids unproductive consumption of MDI and thus permits saving of MDI in rigid PIR foam production, which leads to a cost saving. Furthermore, the saved amount of MDI can be utilized in times of MDI shortage on the world market to expand production of rigid foams.

Surprisingly, it has been found that lactams, organic phosphates and phosphonates particularly meet the relevant requirements. For the purposes of this invention, suitable solvents include but are not limited to amides, lactams, and phosphorous, phosphoric, or phosphonic esters, and also sulfoxides, in particular dimethyl sulfoxide (DMSO). In one embodiment of the invention, organic phosphates and phosphonates include but are not limited to triethyl phosphate (TEP), the ethyl ester of phosphoric acid. In another embodiment of the invention, the lactam includes but is not limited to N-methyl-2-pyrrolidone (NMP), the lactam of 4-methylaminobutyric acid, which moreover features excellent hydrolysis resistance.

This was unexpected for a number of reasons:
Many solvents were tested for their solution properties with respect to potassium octoate. Very few exhibited adequate solvent power to achieve concentrations of 50% by weight and above. Another requirement posing compliance difficulties is low viscosity. There is no scientific model permitting reliable and precise prediction of solubilities and solution viscosities. It is particularly preferable that the inventive catalyst system have low viscosity of up to about 7000 mPa·s, in particular up to about 3000 mPa·s. In each case, one embodiment of the lower viscosity limit is at least about 100 mPa·s. In each case, another embodiment of the lower viscosity limit is at least about 1000 mPa·s. All viscosities measured using Höppler at 25° C.
Solvents for the purposes of the invention can form fairly stable solvate complexes with the dissolved substance. The salvation process can therefore have an effect on the catalytic properties of a dissolved catalyst. Nevertheless, the catalytic activities of concentrated solutions of potassium octoate in NMP and in TEP are precisely the same as those of equivalent solutions in glycols.
Amides and lactams are derivatives of amines. Amines are used as catalysts for the NCO/OH reaction in polyurethane formulations. However, it has been found that amides and lactams have no significant catalytic properties. There is therefore no requirement for rebalancing of the amine catalysis of the formulation when these solvents are used as a constituent of the trimerization catalyst.

Marked “plasticizer properties” could be expected for the inventive solvents, whereas mono- or diethylene glycol is incorporated into the structure of the polyurethane and counts as part of the hard segments of the polymer. Nevertheless, the mechanical properties of PIR foams produced with the inventive catalysts are not significantly different from those of corresponding foams produced with conventional catalysts.

The inventive trimerizaton catalyst systems are therefore in particular used for the trimerization of isocyanates to give isocyanurates and/or polyisocyanurates, utilizing the advantages described.

Against this background, the invention also provides a process for production of PIR foams, comprising polyaddition reactions of substrates containing hydroxy groups and of organic isocyanates, and also crosslinking trimerization reactions of isocyanate groups to give polymer-bonded isocyanurates, which comprises using an inventive trimerization catalyst system for the trimerization of the isocyanate groups.

In one embodiment of the invention organic diisocyanates, for example methylene 4,41-bis(phenyl isocyanate) (MDI), but other mono-, di-, tri-, oligo-, and/or polyiso-cyanates can also be used - in combination or individually.

The inventive process, with trimerization catalyst systems based on phosphorous, phosphoric, or phosphonic esters, can give PIR foams which feature exceptionally low content of other added flame retardants, with constant high flame retardancy. In one embodiment of the invention, the amount of other flame retardants is less than 0.1% by weight based on the weight of the PIR foam. In an another embodiment of the invention, the amount of other flame retardants is less than 0.01% by weight based on the weight of the PIR foam. In each case, one embodiment of the lower limit of the amount of flame retardants is 0% by weight. In each case, another embodiment of the lower limit of the amount of flame retardants is 0.001% by weight.

The invention is further described by the following non-limiting examples which further illustrate the invention, and are not intended, nor should they be interpreted to, limit the scope of the invention.

### EXAMPLES

Experiment Method:

The three formulations of the examples were foamed by a manual mixing process. By this, polyol, flame retardant, amine catalyst, conventional and, respectively, inventive trimerization catalyst, water, foam stabilizer, and blowing agent were weighed out into a beaker (in each case 100 g of polyol, and the other components corresponding to the stated proportions by weight), and were mixed for 30 s at 1000 rpm by a disk stirrer (diameter 6 cm). The amount of blowing agent lost by evaporation during the mixing procedure was determined via reweighing and replaced. The MDI was then added and the reaction mixture was stirred at 3000 rpm for 5 s by the stirrer described, and immediately transferred to a paper-lined box mold (base: 14 cm×28 cm, wall height: 14 cm) with open top.

Cream time (time from start of mixing of components to start of foaming process), string time (time from start of mixing to juncture at which a rod inserted into the foam begins to draw fibers on removal), full rise time (time from start of mixing to end of visible foam rise), and tack-free time (time from start of mixing to achievement of tack-free condition) were determined manually.

One day after the foaming process, the foams were analyzed. Surface and the level of internal defects were assessed subjectively. The following evaluations were available for the level of internal defects: extremely low, very low, quite low, moderate, high, very high, and extremely high. The pore structure (average number of cells per 1 cm) was assessed optically on a cut surface via comparison with comparative foams. Free rise density was determined via weighing of cubic test specimens with edge length 10 cm, sawn from the middle of the foams. Compressive strength with the foams were measured on cubic test specimens with edge length 5 cm to DIN 53421 up to 10% compression (the maximum compressive stress arising in this range of measurement being stated). In each case, a number of test specimens was subjected to load in the direction of foam rise and perpendicularly thereto. Coefficient of thermal conductivity was measured on plaques of thickness 2.5 cm using Hesto X Control equipment, the temperatures at the lower and upper side of the specimens being 10° C. and 36° C.

The following inventive examples and comparative examples were used to demonstrate the MDI-saving potential of the inventive trimerization catalysts:

### Comparative Example 1

(Non-Inventive):

PIR formulation (index <260>) with conventional trimerization catalyst (potassium octoate at 75% strength in MEG Kosmos® 75 MEG, OH number=600)

Comparative example 1:
(non-inventive):
PIR formulation (index <260>) with conventional trimerization
catalyst (potassium octoate at 75% strength in MEG Kosmos ®
75 MEG, OH number = 600)

| | | |
|---|---|---|
| 100 | parts by weight | of aromatic polyester polyol |
| 20 | parts by weight | of TCPP (flame retardant) |
| 0.3 | parts by weight | of PMDETA (amine catalyst for the |
| | | NCO/OH reaction) |
| 5.0 | parts by weight | of KOSMOS ® 75 MEG |
| 0.9 | parts by weight | of water |
| 2.0 | parts by weight | of polyether silicone (foam stabilizer) |
| 17 | parts by weight | of cyclo/isopentane mixture (blowing agent) |
| 207 | parts by weight | of polymeric MDI |

Inventive example 1:
With potassium octoate at 70% strength in NMP, 1.5% water, OH
number = 93)

| | | |
|---|---|---|
| 100 | parts by weight | of aromatic polyester polyol |
| 20 | parts by weight | of TCPP (flame retardant) |
| 0.3 | parts by weight | of PMDETA (amine catalyst for the |
| | | NCO/OH reaction) |
| 5.4 | parts by weight | of 70% strength potassium octoate solution |
| | | in NMP |
| 0.9 | parts by weight | of water |
| 2.0 | parts by weight | of polyether silicone (foam stabilizer) |
| 17 | parts by weight | of cyclo/isopentane mixture (blowing agent) |
| 191 | parts by weight | of polymeric MDI |

Inventive example 2:
With potassium octoate at 70% strength in TEP, 1.5% water, OH
number = 93)

| | | |
|---|---|---|
| 100 | parts by weight | of aromatic polyester polyol |
| 20 | parts by weight | of TCPP (flame retardant) |
| 0.3 | parts by weight | of PMDETA (amine catalyst for the |
| | | NCO/OH reaction) |
| 5.4 | parts by weight | of 70% strength potassium octoate solution |
| | | in TEP |
| 0.9 | parts by weight | of water |
| 2.0 | parts by weight | of polyether silicone (foam stabilizer) |
| 17 | parts by weight | of cyclo/isopentane mixture (blowing agent) |
| 191 | parts by weight | of polymeric MDI |

Results:

| | Comparative | Inventive | Inventive |
|---|---|---|---|
| | example 1 | example 1 | example 2 |
| Cream time [s] | 15 | 14 | 14 |
| Fiber time [s] | 28 | 30 | 26 |
| Full rise time [s] | 47 | 47 | 45 |
| Tack-free time [s] | 48 | 49 | 46 |
| Surface | almost | almost | almost |
| | smooth | smooth | smooth |
| Level of internal defects | very low | very low | very low |
| Pore structure [cells/cm] | 44-48 | 44-48 | 44-48 |
| Envelope density [kg/m³] | 29.3 | 29.0 | 29.4 |
| Compressive strength [kPa]* | 221 (↑↓) | 213 (↑↓) | 216 (↑↓) |
| | 42 (↑→) | 46 (↑→) | 41 (↑→) |
| Coefficient of thermal | 20.3 ± 0.3 | 20.4 ± 0.2 | 20.1 ± 0.3 |
| conductivity [mW/m · K] | | | |

*↑↓ in direction of rise, ↑→ perpendicularly to direction of rise

At identical product yield, the MDI saving in the inventive examples was 7.6% by weight.

For all three formulations, rise behavior and reaction behavior was almost identical, as also were the defect profiles and the physical properties of the foams.

Having thus described in detail various embodiments of the present invention, it is to be understood that the invention defined by the above paragraphs is not to be limited to particular details set forth in the above description as many apparent variations thereof are possible without departing from the spirit or scope of the present invention.

What is claimed is:

1. A trimerization catalyst system for isocyanates, comprising at least about 50% by weight of potassium octoate and a hydroxy-group-free and amino-group-free solvent which, under the reaction conditions, is inert toward the isocyanates used.

2. The trimerization catalyst system as claimed in claim 1, whose potassium octoate content is at least about 60% by weight.

3. The trimerization catalyst system as claimed in claim 1 or 2, which comprises one or more hydroxy-group-free and amino-group-free amides, lactams, and/or phosphorous, phosphoric, or phosphonic esters, or sulfoxides.

4. The trimerization catalyst system as claimed in claim 3, which comprises triethyl phosphate (TEP), or comprises N-methyl-2-pyrrolidone (NMP), or comprises dimethyl sulfoxide (DMSO).

5. The trimerization catalyst system of claim 1, whose viscosity is up to 7000 mPa·s (Höppler at 25° C.).

6. A method for the trimerization of isocyanates to produce isocyanurates and/or polyisocyanurates which comprises of adding a trimerizing effective amount of the trimerization catalyst system of claim 1 to a solution containing a stoichiometric excess of isocyanate.

7. A process for production of PIR foams, comprising polyaddition reactions of substrates containing hydroxy groups and of organic isocyanates, and also crosslinking trimerization reactions of isocyanate groups to give polymer-bonded isocyanurates, which comprises using a trimerization catalyst system as claimed in claim 1 for the trimerization of the isocyanate groups.

8. The process as claimed in claim 7, wherein one or more organic diisocyanates are added.

9. The trimerization catalyst system as claimed in claim 2, whose potassium octoate content is from about 65 to about 90% by weight.

10. The trimerization catalyst system as claimed in claim 9, whose potassium octoate content is from about 65 to about 75% by weight.

11. The trimerization catalyst system of claim 5, whose viscosity is up to 3000 mPa·s (Höppler at 25° C.).

12. The process as claimed in claim 7, wherein methylene 4,4′-bis(phenyl isocyanate) (MDI) is added.

13. The trimerization catalyst system, as claimed in claim 1, whose potassium octoate content is from about 65 to about 75% by weight and whose viscosity is up to 3000 mPa·s (Höppler at 25° C.).

14. The process as claimed in claim 13, wherein methylene 4,4′-bis(phenyl isocyanate) (MDI) is added.
